(19) United States
(12) Patent Application Publication
(10) Pub. No.: US 2011/0263029 A1
(43) Pub. Date: Oct. 27, 2011

(54) Methods And Kits For The Determining The Presence Or Absence Of Ergot Alkaloids

(75) Inventor: Stuart A. Oehrle, Highlands Heights, KY (US)

(73) Assignee: WATERS TECHNOLOGIES CORPORATION, Milford, MA (US)

(21) Appl. No.: 13/123,955

(22) PCT Filed: Oct. 16, 2009
(86) PCT No.: PCT/US09/60950

§ 371 Date: Jun. 17, 2011

Related U.S. Application Data
(60) Provisional application No. 61/106,169, filed on Oct. 17, 2008.

(51) Int. Cl. G01N 31/00

(52) U.S. Cl. 436/8; 436/96

(57) ABSTRACT

The present invention is directed to methods and kits for the determining the presence or absence of ergot alkaloids in sample which use chromatographic instrumentation and columns operating at a pressure of 4,000 to 15,000 psi and columns with 1-3 micron particle size to produce results by mass spectroscopy in approximately four minutes.

### CROSS-REFERENCE TO RELATED APPLICATIONS

This application claims benefit of and is a continuation of U.S. Provisional Application. No. 61/106,169, filed Oct. 17, 2008. The contents of this application is expressly incorporated herein by reference in its entirety.

### STATEMENT REGARDING FEDERALLY SPONSORED RESEARCH OR DEVELOPMENT

The inventions of the present application were not made with Federal or state funds or grants.

### THE NAMES OF THE PARTIES TO A JOINT RESEARCH AGREEMENT

The inventions of the present application were not made under a joint research agreement.

### REFERENCE TO SEQUENCE LISTING

The present application does not have any nucleic acid, peptide or protein sequence.

### BACKGROUND OF THE INVENTION

Ergot alkaloids are mycotoxins produced by grass and grain that can produce toxins that are deadly to cattle and other animals. In addition these toxins, at non-toxic levels can be absorbed into tissue and potentially be transferred through the consumption of meat products from animals exposed to these materials. Several significant ergot alkaloids are depicted in FIG. 1.

This paper will use the term “analyte” to denote a compound which one desires to determine the presence of absence of.

This paper will use the term “sample” to mean a material which one desires to test for the presence or absence of ergot alkaloids. The sample may be obtained as tissues or fluids from animals or plants. For example, without limitation, the sample may comprise leaves, seeds or other plant tissues or blood, urine, saliva or tissues obtained from animal sources.

An “extract” is a solution obtained by subjecting a sample to a solvent such that one or more compounds held in the sample are dissolved in the solution.

An “aliquot” is used to denote a subpart or fraction of a sample.

Chromatography is a method of separating compounds in a solution. Chromatography can be performed in different devices. This paper will use the term “cartridge” to refer to low pressure devices comprising a column and/or funnel in a solid phase is placed. The sample is applied to the solid phase and passes through under low pressure or gravity. These devices are typically used to prepare a sample by removing particulates and concentrating desired compounds.

For the purpose of this paper, the term “column” will be used in the sense of a high pressure device in which solutions are forced through a solid phase matrix under pressure. The solid phase can be particulate or a porous monolith.

Mass spectrometry is used to determine the mass to charge ratio of ions formed by compounds. Mass spectrometers are used to form fragments of larger molecules and such fragments and complete ions are used to identify such compounds.

Standards are solutions with known amounts of compounds which solutions are used to compare data to data derived from non-standard samples. Standards can use compounds with labels comprising heavy isotopes which allow the operator of the mass spectrometer to differentiate between the standard and the analyte.

Interest in reliable and fast analysis of these compounds is needed to prevent the misidentification of potentially tainted feed stock as well as meat products. Prior to the present invention, the methods used to detect ergot alkaloids in grass and grain were not specific or sensitive to analyze for these compounds. Prior to the present invention, the methods were time consuming and labor intensive.

### SUMMARY OF THE INVENTION

Embodiments of the present invention are directed to kits and methods for determining the presence of absence of ergot alkaloids in samples. The methods and kits of the present invention feature the reliable and fast analysis, or detection, of these compounds. These methods and kits have particular utility to prevent the misidentification of potentially tainted feed stock as well as meat products.

One embodiment of the present invention directed to a method of determining the presence or absence of ergot alkaloids in a sample has several steps. These steps are preparing a sample by extracting compounds potentially comprising ergot alkaloids with one or more organic solvents to form a sample extract. Next, the method comprises the step of placing the sample extract on the head of a chromatographic column packed with particles having a mean particle size of 1 to 3 microns under pressure of 4,000 to 15,000 psi to form a retained ergot alkaloid in the event the sample extract contained such ergot alkaloid. Next, the ergot alkaloid is eluted under a gradient of organic solvent to form an eluted ergot alkaloid, in the event said sample extract contained such ergot alkaloid. This eluted ergot alkaloid, if present, is placed in a mass spectrometer to form a mass spectra and the presence or absence of the ergot alkaloid is determined from the mass spectra.

Preferably, the mass spectrometer forms one or more fragments of the ergot alkaloid. The formation of fragments in mass spectroscopy is sometimes denoted as MS/MS. The spectra of the fragments are used to identify and determine the presence or absence of an ergot alkaloid.

Preferably, the identification of the ergot alkaloid, if present, is facilitated by placing one or more standards comprising a known labeled ergot alkaloid on the head of a column to be retained and eluted in the manner of sample ergot alkaloids. The eluted standard ergot alkaloid is placed in a mass spectrometer to form a known spectra of the standard ergot alkaloid to which sample spectra are compared.

A preferred column has a particle bed in which such particles exhibit a surface chemistry of a bridged ethyl, hybrid preferably with a bonded C18 groups. A preferred particle is one to three microns in diameter and preferably less than two microns. Such columns featuring small particles are used in chromatographic systems which perform at pressures of 4,000 to 15,000 psi.

The small particle column and high pressure performance of the chromatography system allow the method steps of placing the sample extract on the head of a chromatographic column, eluting and placing said ergot alkaloid in a mass spectrometer to be performed in a time period of three to fifteen minutes, and routinely in a period of four minutes.

Preferably, the sample extract is formed by placing ground or particular raw sample in an extraction cartridge. A preferred extraction cartridge has a solid particulate bed in which the particles have a surface chemistry of poly(divinylbenzene-co-N-vinylpyrrolidone). The surface chemistry allows the particles of the extraction column to retain ergot alkaloids on a water wettable surface.

One embodiment of the present invention features a kit for performing the method. As used herein, the term kit refers to a collection of parts and reagents bundled together with suitable packaging and instructions for their use. One kit for performing an analysis of a sample for the presence or absence of ergot alkaloids, in accordance with the present invention comprises standards for calibrating and facilitating the identification of one or more ergot alkaloids by mass spectroscopy; sample preparation devices for forming sample extract, a column for separating the compounds of the sample extract and upon application of a gradient releasing said ergot alkaloids, if present, such that said ergot alkaloids are released to a mass spectrometer for identification.

A preferred column has a particle size of 1-3 microns. A preferred column has a chromatographic surface comprising a bridged ethyl hybrid, preferably with a bonded C18 groups. And, preferably, the column has an operating pressure of 4,000 to 15,000 psi.

These and other features and advantages will be apparent to those skilled in the art upon viewing the Figures identified below and reading the Detail Description that follows.

### BRIEF DESCRIPTION OF THE FIGURES

FIG. 1 depicts ergot-type alkaloids;

FIG. 2 depicts in schematic form an instrument for performing the method of the present invention; and

FIG. 3 depicts a kit embodying features of the present invention;

### DETAILED DESCRIPTION OF THE INVENTION

Embodiments of the present invention will be described in detail as kits and methods for determining the presence of absence of ergot alkaloids in samples. The methods and kits described are preferred embodiments of the present invention reflecting the best mode of practicing the invention. Of course, methods and kits of the present invention described herein are capable of being modified and altered without departing from the teaching herein. Thus, the following discussion should not be construed as limiting.

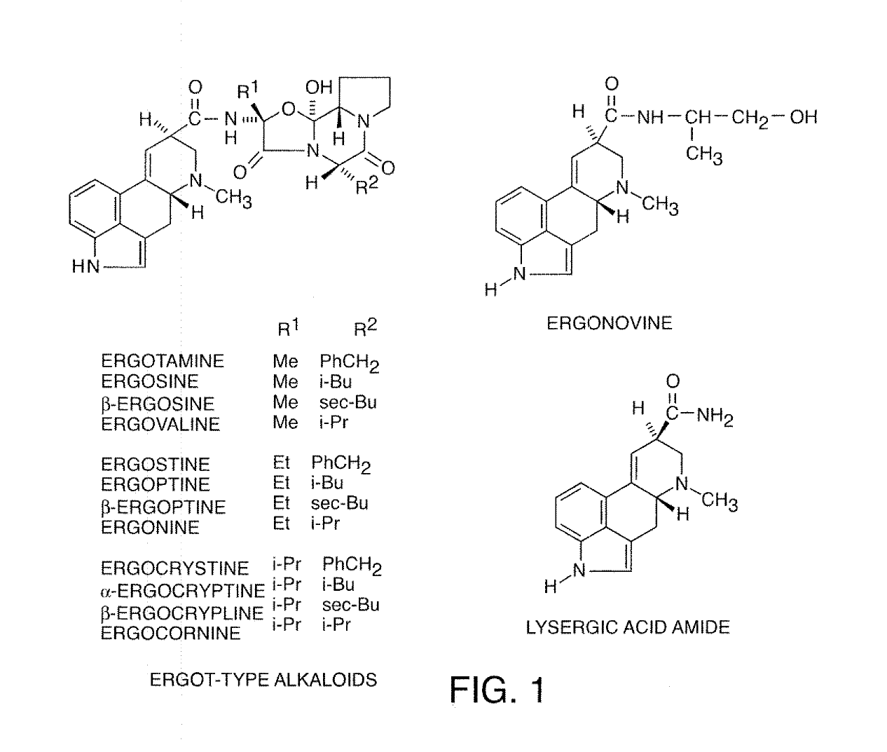

Ergot-type alkaloids are depicted in FIG. 1. Any one or more of such ergot alkaloids may be present in fescue or grasses, other plant materials which can serve as feed for animals or foodstuff for people. These materials are deemed to be toxins. Livestock feeding on feed contaminated with ergot alkaloids can carry such into the human feedstuff as meat and dairy products. Thus, it is desirable to have a fast, sensitive means for the detection of ergot alkaloids in plant material and animal tissues and biological fluids.

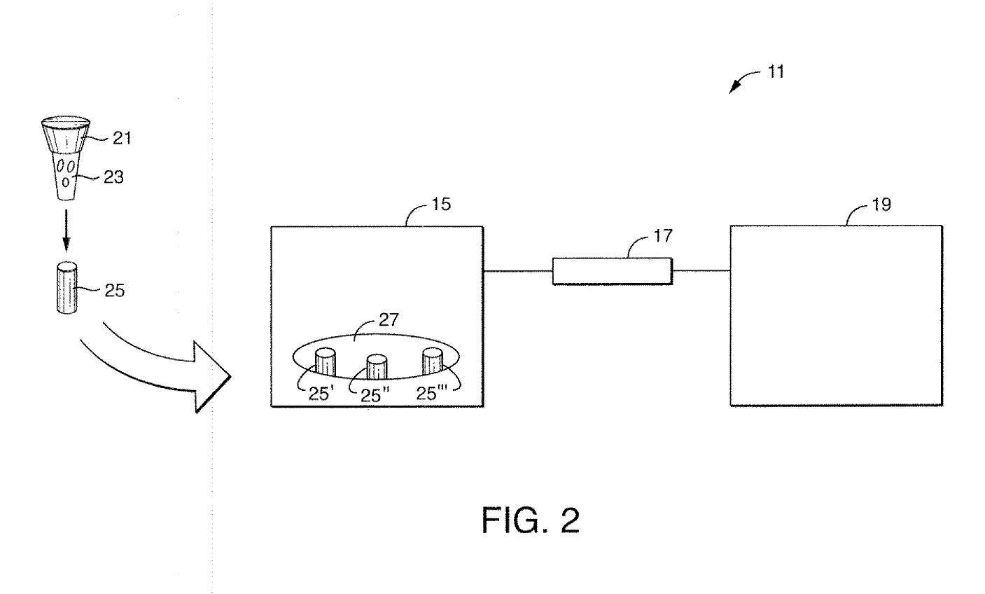

Turning next to FIG. 2, a schematic of an instrument for performing an embodiment of the present method is depicted. The instrument, generally designated by the numeral 11, has the following major elements: a chromatography system 15, a column 17 and a mass spectrometer 19.

A preferred method of determining the presence or absence of ergot alkaloids in a sample has several steps. And, such preferred method begins with the step of preparing a sample by extracting compounds potentially comprising ergot alkaloids with one or more organic solvents to form a sample extract. A sample extraction cartridge is depicted in FIG. 2, designated by the numeral 21. Preferred solvents dichloromethane, methanol, ethanol, ethyl acetate, chloroform, acetonitrile, singularly or as mixtures, with or without water.

Preferably, the sample extract is formed by placing ground or particular raw sample in an extraction cartridge 21. Methods of grinding a sample such as leaves and seeds are well known in the art.

Extraction cartridge 21 is depicted in cross section in FIG. 2, and has a solid particulate bed 23. The particles have a surface chemistry of poly(divinylbenzene-co-N-vinylpyrrolidone). That is, the particles may totally comprise the polymer or such polymer is carries as a surface layer on a substrate that is selected from a different material. Common materials which may be used as a substrate include, by way of example, without limitation, silica, aluminium and titanium oxides and other polymeric compounds. The surface chemistry of poly(divinylbenzene-co-N-vinylpyrrolidone) allows the particles of the extraction column to retain ergot alkaloids on a water wettable surface.

Extraction cartridges having a surface chemistry of poly(divinylbenzene-co-N-vinylpyrrolidone) are sold by Waters Corporation (Milford, Mass., USA) under the trademark OASIS® HLB. Extraction cartridges without a surface chemistry of poly(divinylbenzene-co-N-vinylpyrrolidone) may be used. Such extraction cartridges are sold by Waters Corporation (Milford, Mass., USA) under the trademark SEP-PAK.

The sample extract is placed in a vial 25 for convenience of handling. The vial is placed in a chromatography system 15 autosampler, depicted in schematic form as a circular tray 27 holding vials 25′, 25″, and 25′″. Chromatography systems are well known in the art. A preferred chromatography system 15 has an operating pressure of 4,000 to 15,000 psi. Such chromatography systems 15 are sold by Waters Corporation (Milford, Mass., USA) under the trademark ACQUITY®.

Next, as depicted in FIG. 2, the method comprises the step of placing the sample extract on the head of chromatographic column 17. Chromatographic column 17 is packed with particles having a mean particle size of 1 to 3 microns. Chromatographic column 17 has an operating pressure of 4,000 to 15,000 psi. A preferred column has particles with a chromatographic surface of a bridged ethyl hybrid composition preferably with bonded C18 groups. Such columns 17, having a 1.7 micron particle size, are sold by Waters Corporation (Milford, Mass., USA) under the trademark ACQUITY® with a BEH designation. Such columns are sold in 2.1×100 mm and 50 mm. configurations. In the event the sample extract held in vials 25′, 25″ or 25′″ has one or more ergot alkaloids, a retained ergot alkaloid is held on the particles until eluted under gradient conditions.

Next, the ergot alkaloid is eluted under a gradient of organic solvent to form an eluted ergot alkaloid, in the event said sample extract contained such ergot alkaloid. A preferred gradient comprises a first solvent comprising 0.1% NH₄OH (H₂O) and a second solvent comprising 0.1% NH₄OH (acetonitrile). The gradient is applied at a flow rate of 0.1 to 1.0 ml/min, and more preferably, at about 0.5 ml/min over a period of approximately six minutes moving from 90% of the first solvent to 90% of the second solvent.

This eluted ergot alkaloid, if present, is placed in a mass spectrometer 19 to form a mass spectra. The presence or absence of the ergot alkaloid is determined from the mass spectra.

Preferably, the mass spectrometer forms one or more fragments of the ergot alkaloid. The formation of fragments in mass spectroscopy is sometimes denoted as MS/MS and is known to those skilled in the art. The spectra of the fragments are used to identify and determine the presence or absence of an ergot alkaloid. A preferred mass spectrometer is sold by Waters Corporation (Milford, Mass., USA) under the trademark MICROMASS® TQC.

Preferably, the identification of the ergot alkaloid, if present, is facilitated by placing one or more standards comprising a known ergot alkaloid or istopically labeled ergot alkaloid on the head of a column to be retained and eluted in the manner of sample ergot alkaloids. The eluted standard ergot alkaloid is placed in a mass spectrometer to form a known spectra of the standard ergot alkaloid to which sample spectra are compared. Such labeled ergot alkaloids are normally deuterated forms known to individuals skilled in the art.

The small particle column and high pressure performance of the chromatography system allow the method steps of placing the sample extract on the head of a chromatographic column, eluting and placing said ergot alkaloid in a mass spectrometer to be performed in a time period of three to fifteen minutes, and routinely in a period of four minutes.

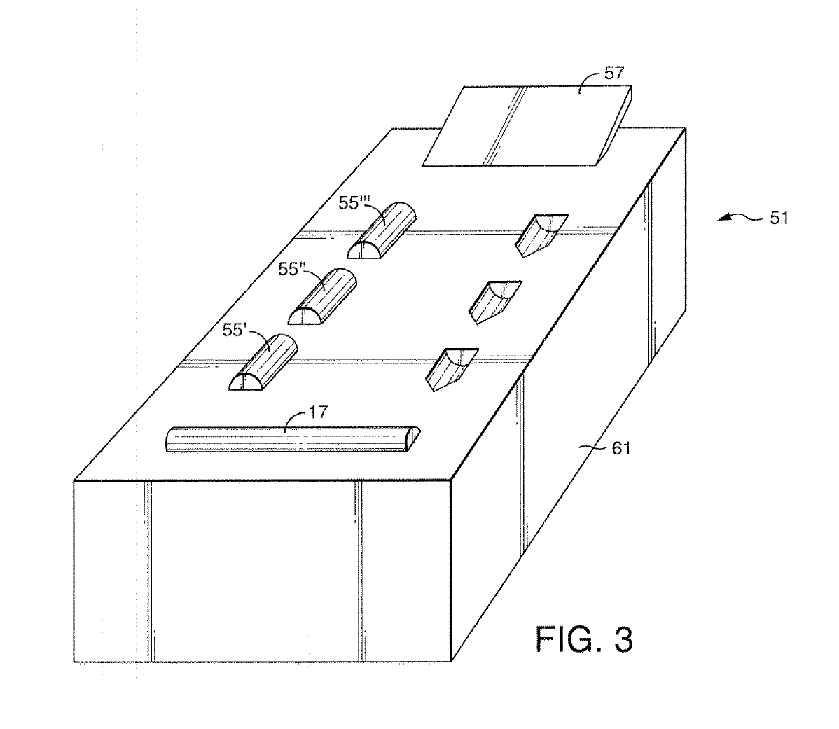

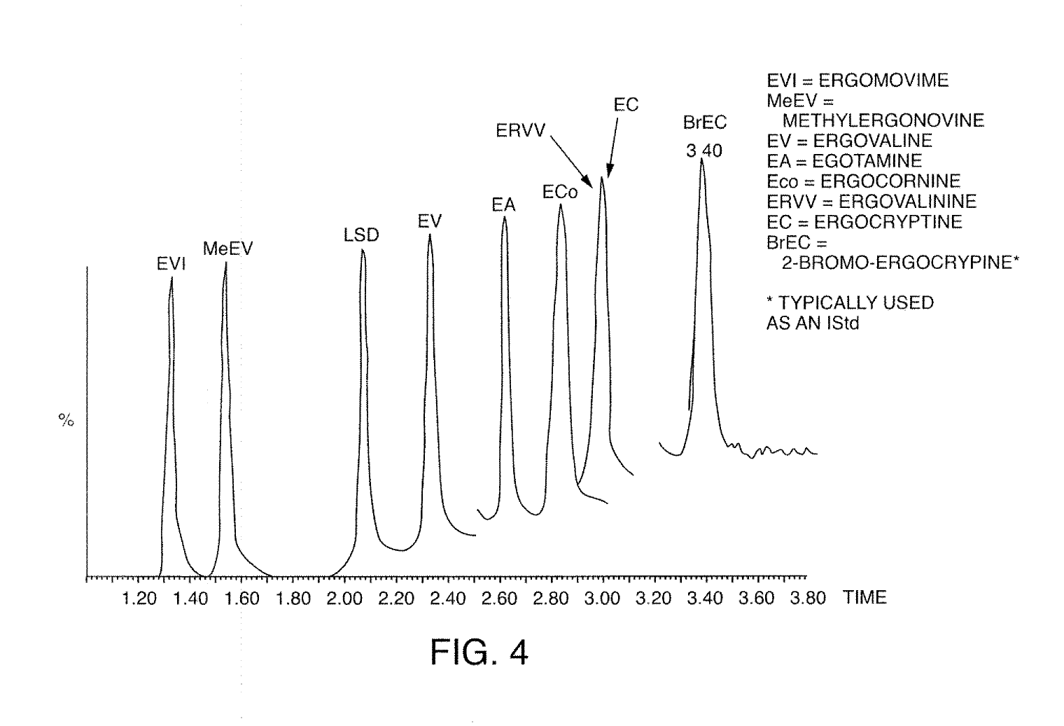

Turning now to FIG. 3, a kit embodying features of the present invention, generally designated by the numeral 51, is illustrated. The kit is a collection of parts and reagents bundled together with suitable packaging and instructions for their use in the method described above. Kit 51 comprises one or more standard vials, of which three are depicted designated 55′, 55″ and 55′″, containing standard solutions for calibrating and facilitating the identification of one or more ergot alkaloids by mass spectroscopy. The kit 51 further comprises one or sample preparation devices in the form of extraction cartridges, of which three are depicted 21′, 21″, and 21′″ for forming sample extract. The kit further comprises a column 17 for separating the compounds of the sample extract and upon application of a gradient releasing said ergot alkaloids, if present, such that said ergot alkaloids are released to a mass spectrometer for identification. The kit 51 further comprises instructions 57 for the use of these parts and reagents in the method as previously described. The kit is depicted with suitable packaging, which is known in the art, and may comprise plastic wraps and bubble shells, boxes, wrapping and the like.

Further features of the present invention are described with respect to the following examples.

### EXAMPLE

### Example 1

### Extraction of Ergot Alkaloids from Seeds

Approximately 0.5 g of seed is weighed and placed in a large scintillation vial. 10 mL of a 80% MeOH/20% lab purified water is added to the vial. The vial is loosely capped and sonicated for approx 10-15 minutes, than allowed to stand for approx 1 hour, The sample is than vortexed to loosen any clumps of grass material from the bottom and than using a glass pipet with a small piece of glass wool in it to catch any large solid material, 3 mL is transferred to a preconditioned Waters Sep-Pak C18 cartridge.

The first few mL's of extract were pushed through and the last approx 1 mL is collected and used for HPLC/MS/MS analysis.

The 1 ml aliquot of the sample extract is placed on the head of a 2.1 by 50 mm or 2.1 by 100 mm ACQUITY® BEH C18 (1.7 micron) chromatographic column at 35 degrees Centigrade at a flow rate of 0.5 ml/min. the ergot alkaloid is eluted under a gradient of organic solvent to form an eluted ergot alkaloid, in the event said sample extract contained such ergot alkaloid. A preferred gradient is a first solvent comprising 0.1% NH₄OH (H₂O) and a second solvent comprising 0.1% NH₄OH (acetonitrile). The gradient is applied at a flow rate of about 0.5 ml/min over a period of approximately six minutes moving from 90% of the first solvent to 90% of the second solvent.

The eluted ergot alkaloid is directed into a MICROMASS® TQD mass spectrometer and peaks identified by retention time as set forth below are obtained.

Retention window (mins): 1.000 to 1.750 (EVI)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 326.27 > 208.15 | 0.050 | 40.0 | 28.0 | 0.020 |
| 2: 326.27 > 223.17 | 0.050 | 40.0 | 24.0 | 0.005 |

Retention window (mins): 1.250 to 2.000 (MeEV)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 340.25 > 207.24 | 0.050 | 40.0 | 68.0 | 0.020 |
| 2: 340.25 > 222.65 | 0.050 | 40.0 | 58.0 | 0.005 |

Retention window (mins): 1.800 to 2.500 (LSD)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 324.31 > 208.08 | 0.050 | 40.0 | 30.0 | 0.020 |
| 2: 324.31 > 223.16 | 0.050 | 40.0 | 24.0 | 0.005 |

Retention window (mins): 2.150 to 2.600 (EV)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 534.39 > 208.13 | 0.050 | 45.0 | 42.0 | 0.020 |
| 2: 534.39 > 223.21 | 0.050 | 45.0 | 34.0 | 0.005 |

Retention window (mins): 2.500 to 3.000 (EA)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 582.30 > 223.20 | 0.050 | 40.0 | 34.0 | 0.020 |
| 2: 582.20 > 564.20 | 0.050 | 35.0 | 15.0 | 0.005 |

Retention window (mins): 2.700 to 3.100 (ECo)
Ionization mode: ES+
Data type: SIR or MRM data
Function type: MRM of 2 channels

| Chan Reaction | Dwell (secs) | Cone Volt. | Col. Energy | Delay (secs) |
|---|---|---|---|---|
| 1: 562.30 > 223.30 | 0.050 | 40.0 | 35.0 | 0.020 |
| 2: 562.30 > 544.30 | 0.050 | 40.0 | 15.0 | 0.005 |

Retention window (mins): 2.700 to 3.500 (ERVV and EC)
Ionization mode: ES+
Data type: SIR or MRM data
Function type: MRM of 4 channels

| Chan Reaction | Dwell (secs) | Cone Volt. | Col. Energy | Delay (secs) |
|---|---|---|---|---|
| 1: 534.30 > 223.20 | 0.050 | 30.0 | 30.0 | 0.020 |
| 2: 534.30 > 516.30 | 0.050 | 30.0 | 18.0 | 0.005 |
| 3: 576.41 > 268.17 | 0.050 | 45.0 | 26.0 | 0.005 |
| 4: 576.41 > 558.20 | 0.050 | 45.0 | 60.0 | 0.005 |

Retention window (mins): 3.200 to 3.800 (BrEC)
Ionization mode: ES+
Data type: SIR or MRM data
Function type: MRM of 3 channels

| Chan Reaction | Dwell (secs) | Cone Volt. | Col. Energy | Delay (secs) |
|---|---|---|---|---|
| 1: 654.20 > 636.20 | 0.050 | 40.0 | 18.0 | 0.020 |
| 2: 654.20 > 654.20 | 0.050 | 40.0 | 5.0 | 0.005 |
| 3: 656.20 > 638.20 | 0.050 | 40.0 | 18.0 | 0.005 |

### Compound Key

### EVI=Ergomovime

### MeEV=MethylErgonovine

### EV=Ergovaline

### EA=Egotamine

### Eco=Ergocornine

### ERVV=Ergovalinine

### EC=Ergocryptine

### BrEC=2-Bromo-ergocrypine

This data is summarized in FIG. 4.

In addition, N-Acetyl Loline (NAL) exhibits a peak at 1.20 minutes
Ionization mode: ES+,
Data type: SIR or MRM data, and
Function type: MRM of 3 channels

Thus, we have described the invention with respect to the preferred embodiment with the understanding that the invention is capable of modification and alteration without departing from the teaching. Therefore, the invention should not be limited to the precise details set forth herein but should encompass the subject matter of the claims that follow and their equivalence.

What is claimed:

1. A method of determining the presence or absence of ergot alkaloids in a sample comprising the steps of:
preparing a sample by extracting compounds potentially comprising ergot alkaloids with one or more organic solvents to form a sample extract,
placing said sample extract on the head of a chromatographic column packed with particles having a mean particle size of 1 to 3 microns under pressure of 4,000 to 15,000 psi to form a retained ergot alkaloid in the event said sample extract contained such ergot alkaloid;
eluting said ergot alkaloid under a gradient of organic solvent to form an eluted ergot alkaloid, in the event said sample extract contained such ergot alkaloid; and
placing said eluted ergot alkaloid in a mass spectrometer to form a mass spectra and determining the presence or absence of said ergot alkaloid from the mass spectra.

2. The method of claim 1 wherein said mass spectrometer forms one or more fragments of the ergot alkaloid and said spectra of said fragments is used to identify and determine the presence or absence of said ergot alkaloid.

3. The method of claim 3 wherein said steps of placing said sample extract on the head of a chromatographic column, eluting and placing said ergot alkaloid in a mass spectrometer is performed in a time period of less than fifteen minutes.

4. The method of claim 1 wherein said particle is a bridged ethyl hybrid, with a bound C18 or other group bound to it.

5. The method of claim 1 wherein said particles have a mean average diameter of less than two microns.

6. The method of claim 1 wherein said sample extract is formed by placing ground or particular raw sample in an extraction cartridge.

7. The method of claim 6 wherein said extraction cartridge has particle comprising a polymer poly (divinylbenzene-co-N-vinylpyrrolidone).

8. A kit for performing an analysis of a sample for the presence or absence of ergot alkaloids, comprising:
standards for calibrating and facilitating the identification of one or more ergot alkaloids by mass spectroscopy,
sample preparation devices for forming sample extract,
a column for separating the compounds of the sample extract and upon application of a gradient releasing said ergot alkaloids, if present, such that said ergot alkaloids are released to a mass spectrometer for identification.

9. The kit of claim 8 wherein said column is has a particle size of 1-3 microns.

10. The kit of claim 9 wherein said particle has a chromatographic surface comprising a bridged ethyl hybrid having bonded C18 groups.

11. The kit of claim 10 wherein said column has an operating pressure of 4,000 to 15,000 psi.
